(19) United States
(12) Patent Application Publication
(10) Pub. No.: US 2026/0221587 A1
(43) Pub. Date: Jul. 30, 2026

(54) Battery Pack and Motor Vehicle Having Battery Pack

(71) Applicant: Bayerische Motoren Werke Aktiengesellschaft, Muenchen (DE)

(72) Inventors: Franz FUCHS, Muenchen (DE); Viola KNOEDLER, Wolnzach (DE); Bjoern WAHL, Muenchen (DE); Sascha ZIMMERMANN, Muenchen (DE)

(21) Appl. No.: 19/140,412

(22) PCT Filed: Feb. 5, 2024
(86) PCT No.: PCT/EP2024/052699

§ 371 Date: Jun. 18, 2025

(30) Foreign Application Priority Data
Mar. 1, 2023 (DE) 10 2023 105 037.0

(51) Int. Cl. H01M 50/367; H01M 50/213; H01M 50/249; H01M 50/291; H01M 50/293; H01M 50/342; H01M 50/512

(52) U.S. Cl. CPC H01M 50/367; H01M 50/213; H01M 50/249; H01M 50/291; H01M 50/293; H01M 50/3425; H01M 50/512

(57) ABSTRACT

A battery store for an electrically drivable motor vehicle includes a housing, a stabilization plate, and a plurality of cells. The stabilization plate has passages. The plurality of battery cells are disposed within the cell portion and have degassing openings. The degassing openings are each formed on a side of one of the plurality of battery cells facing the stabilization plate and are each assigned to one of the passages. The passages include at least one multi-cell passage to which a plurality of the degassing openings are assigned.

### BACKGROUND AND SUMMARY

The present disclosure relates to a battery store for an electrically drivable motor vehicle and/or to a motor vehicle which comprises the battery store.

Hybrid, plug-in hybrid, fuel-cell and electric vehicles have battery stores (or traction energy stores) which, e.g., are used to receive or provide recuperation energy and drive energy. The battery stores typically comprise battery cells in the form of accumulators, e.g. Li-ion batteries, and have a modular design, wherein individual battery cells are connected in series and/or parallel within a housing.

The battery cells need to be stored as robustly as possible in order to protect the battery cells from damage as reliably as possible when the vehicle is in operation. This is particularly relevant when lithium-ion battery cells are being used since these mostly contain flammable electrolytes which, e.g., could be released in the event that the vehicle crashes and ignited by sparks or electric arcs. Known for this purpose are, e.g., stabilization plates made of steel and which are inserted beneath the battery cells in order to stabilize the battery cells in the event of shock and vibration loads while the vehicle is in operation and to prevent the battery cells from sinking downward.

Furthermore, damage to a battery cell can lead to thermal runaway which can result in the defective battery cell setting on fire or exploding due to overpressure caused by a rapid increase in the cell temperature. Possible damage which can lead to thermal runaway is not only crash load cases but, e.g., also short circuits or excessive electric currents when the battery store is being charged or discharged.

It is known to provide arrangements within the housing in order to be able to dissipate gases in a targeted manner after a battery cell has failed, i.e. after thermal runaway, and thus to keep consequential damage to other battery cells as low as possible.

This dissipation of the gases, which is also referred to as hot degassing, is, e.g., achieved by virtue of passages or holes being provided in the stabilization plates, wherein each passage is assigned to a degassing opening of a battery cell in order to allow the hot degassing of a defective battery cell downward. As a result, the hot degassing can be directed into a portion of the housing interior which is separated from the battery cells, and released in a targeted manner there, e.g. via an opening in the housing.

This known solution of such a stabilization plate having openings has a number of disadvantages, however.

Spaces between the battery cells or between the battery cells and the housing are usually filled with a potting compound, e.g. a foam. When the battery store is being produced, the filling with the foam takes place after the battery cells and the stabilization plate have been inserted into the housing, and so a filling gap, i.e. a distance between the battery cells and the stabilization plate, has to be provided in order that the housing can be filled with the foam through the passages in the stabilization plate. This leads to a loss of installation space for the battery cells on account of the filling gap and the battery cells have to have smaller dimensions. Consequently, the battery cells are able to store less electrical energy, which, e.g., leads to a shorter range of the motor vehicle.

On account of the filling gap, there is also a higher layer thickness of the foam between the respective degassing opening in a battery cell and the assigned passage in the stabilization plate. This higher layer thickness creates a risk of the battery cell bursting open at the sides or of a degassing at the terminal of the battery cell.

Furthermore, thermal runaway can result in uncrimping or another detachment of the entire cell bottom from the battery cell. The detached cell bottom can wedge against the stabilization plate or close off the assigned passage in the stabilization plate such that the hot degassing is redirected through the filling gap to adjacent battery cells. This can lead to critical heating of the adjacent cells and, e.g., to a short circuit.

Against the background of this prior art, the object of the present disclosure consists in specifying a device which is respectively suitable for enhancing the prior art.

This and other objects are achieved by the features of the present disclosure. The present disclosure also discloses optional developments.

Accordingly, the object is achieved by a battery store for an electrically drivable motor vehicle.

The battery store comprises a housing which forms a housing interior.

The battery store comprises a stabilization plate which is disposed in the housing interior and divides the housing interior into a degassing portion and a cell portion. The stabilization plate has passages.

The battery store comprises a plurality of battery cells which are disposed within the cell portion and have degassing openings. The degassing openings are each formed on a side of one of the plurality of battery cells facing the stabilization plate and are each assigned to one of the passages (in the stabilization plate).

The passages (in the stabilization plate) comprise at least one multi-cell passage to which a plurality of the degassing openings are assigned. It is also conceivable for the passages to comprise a plurality of multi-cell passages to each of which a plurality of the degassing openings are assigned.

The (mechanical) stabilization plate (or also: perforated plate, support plate) can be used to stabilize the housing and/or the battery cells, e.g. in the event of shock and/or vibration loads while the vehicle is in operation. The stabilization plate can, e.g., be in the form of a partition wall of the housing.

A degassing opening in a battery cell can be provided in order to release a (hot) gas in the event of increased pressure, e.g. due to a defect in the battery cell, and thus to prevent, e.g., the defective battery cell from exploding.

“Assigned” can mean that the passages in the stabilization plate fluidically connect the degassing openings to the degassing portion. The degassing openings can each be disposed (optionally directly) above one of the passages and/or form passageways to one of the passages.

The at least one multi-cell passage can fluidically connect the plurality of the degassing openings to the degassing portion (at the same time). The plurality of the degassing openings can be disposed (optionally directly) above the at least one multi-cell passage and/or form passageways to the at least one multi-cell passage. In other words, a plurality of the degassing openings can “share” a multi-cell passage.

The above-described battery store offers a number of advantages. Among others, a distance between the stabilization plate and the battery cells can be advantageously reduced or even no distance can be provided. As a result of the fact that at least one multi-cell passage in the stabilization plate is assigned to a plurality of the degassing openings, at least one space between at least two of the plurality of battery cells is accessible via the at least one multi-cell passage. Spaces between the plurality of battery cells and spaces between the plurality of battery cells and the housing can thus be fillable with a potting compound via the accessible space, provided this is desired.

Furthermore, owing to the reduced distance, the battery cells can, e.g., have larger dimensions and thus store a greater amount of electrical energy, which, e.g., leads to a longer range of the motor vehicle drivable by the battery store.

A reduced distance between the stabilization plate and the battery cells can also advantageously lead to a thinner layer thickness of the potting compound between the degassing openings and the passages in the stabilization plate, which leads to a lower degassing resistance, as a result of which the risk of a defective battery cell bursting open at the sides or of a degassing at the terminal of a defective battery cell can be reduced.

In the case of uncrimping or another detachment of the entire cell bottom in the event of thermal runaway, the risk of the cell bottom wedging against the stabilization plate and closing off one of the passages is also advantageously reduced.

Possible developments of the above-described device are explained in detail below.

The at least one multi-cell passage can have a triangular, trapezoidal or hexagonal shape. Advantageously, these shapes are able to be made particularly easily in the stabilization plate in order to form the enlarged passage. Alternatively, any other shape is also conceivable, so long as the at least one multi-cell passage can be assigned to a plurality of the degassing openings.

The at least one multi-cell passage can have the triangular shape, wherein three of the degassing openings can (each) be assigned to the at least one multi-cell passage.

The at least one multi-cell passage can have the trapezoidal shape, wherein four of the degassing openings can (each) be assigned to the at least one multi-cell passage.

The at least one multi-cell passage can have the hexagonal shape, wherein seven of the degassing openings can (each) be assigned to the at least one multi-cell passage.

The plurality of battery cells can be grouped in groups of battery cells connected in parallel, which can optionally be at the same housing potential. Degassing openings of one of the groups can be assigned to the at least one multi-cell passage. Advantageously, in the event of thermal runaway in a battery cell, there is no short circuit through the adjacent battery cells caused by conductive degassing particles since there is no difference in potential.

The plurality of battery cells can lie against the stabilization plate, e.g. lie on the stabilization plate. It is also conceivable for the plurality of battery cells to be able to be disposed spaced apart from the stabilization plate.

The stabilization plate can be formed of at least one electrically insulating material. The stabilization plate can be formed of at least one plastic, e.g. a glass-fiber reinforced plastic (GRP for short), polypropylene (PP for short), polyethylene terephthalate (PET for short), polyethylene (PE for short), a carbon-fiber reinforced plastic (CRP for short) and/or an aramid.

The stabilization plate can be formed by a metal plate which has at least one insulating layer and/or has an insulating plate lying thereagainst.

The plurality of battery cells can be designed as round cells. The plurality of battery cells can be disposed in the cell portion spaced apart from one another.

The passages in the stabilization plate, spaces between the plurality of battery cells and spaces between the plurality of battery cells and the housing can be at least partially, optionally completely, filled with a potting compound, e.g. a foam. The potting compound can be used to mechanically stabilize the battery store and/or the plurality of battery cells within the housing. The potting compound can be electrically insulating and/or thermally conductive or offer improved protection for battery cells in the event of thermal runaway in one of the plurality of battery cells.

The stabilization plate and the plurality of battery cells can be at least partially, optionally completely, disposed in an insulating compound (and/or covered by an insulating compound). The insulating compound can be a foam system which, e.g., comprises polyurethane.

The degassing openings can each be closed by a bursting membrane. The degassing openings can, e.g., also be referred to as vents.

The housing can have an opening closed by a bursting membrane and able to be formed adjacent to the degassing portion. Advantageously, gas can thus be released to the outside in the event of thermal runaway.

That described above can be summarized in other words and in a possible more concrete form of the disclosure as described below, wherein the following description should not be interpreted as limiting the disclosure.

According to the present disclosure, larger passages or holes can be made in the stabilization plate (or support plate), e.g. in the shape of a triangle, prism (or a rhombus and/or a parallelogram) or hexagon, in the case of which a plurality of battery cells “share” a hole.

The stabilization plate can be formed of an insulating material (GRP, PP, PET, PE, CRP, Kevlar, etc.) or of a metal plate which has an insulating layer or has an insulating plate laid thereon.

Owing to the larger passages or holes, no distance has to be necessary between the stabilization plate, optionally an insulated stabilization plate, and the battery cells, provided that the holes in the stabilization plate are cut out larger and cover a plurality of battery cells. A foam can be directly introduced or filled into a cell space. This thus makes it possible to gain installation space in the vertical direction and therefore achieve higher energy contents in the battery store.

A thinner layer thickness of the foam at the respective vent (or degassing opening) can lead to a lower degassing resistance and thus to no or a reduced risk of a battery cell bursting at the sides or of a degassing at the cell terminal.

The layer thickness of the foam can at the same time also be selected to be thick enough to ensure good protection of the neighboring battery cells.

In the case of uncrimping or another detachment of the entire cell bottom in the event of thermal runaway, the larger holes can lead to no or a reduced risk of the cell bottom wedging against the stabilization plate, such that controlled hot degassing can take place, e.g. downward.

Battery cells which are at the same housing potential, e.g. always connected in parallel, can be grouped in the larger passages. If, in this case, in the event of the degassing, a neighboring cell is exposed, there is no short circuit caused by the conductive degassing particles since there is no difference in potential. The risk of a short circuit can be further lowered with respect to the neighboring cells connected in series in the next passage in the stabilization plate since the edges of the passages are stabilized by the protective foam layer.

Furthermore, a motor vehicle which comprises the above-described battery store is provided.

The motor vehicle can be a passenger car, in particular an automobile, or a utility vehicle, such as, e.g., a truck.

The motor vehicle can be electrically drivable (and/or movable) by means of the battery store.

That described above with respect to the battery store also applies analogously to the motor vehicle and vice versa.

An optional embodiment is described below with reference to FIGS. 1, 2, 3 and 4, in which:

### BRIEF DESCRIPTION OF THE DRAWINGS

FIG. 1 schematically shows a known battery store;

FIG. 2 schematically shows a detail of a known stabilization plate;

FIG. 3 schematically shows a battery store according to the disclosure; and

FIG. 4 schematically shows passages, according to the disclosure, in a stabilization plate according to optional embodiments in the assembled state.

### DETAILED DESCRIPTION OF THE DRAWINGS

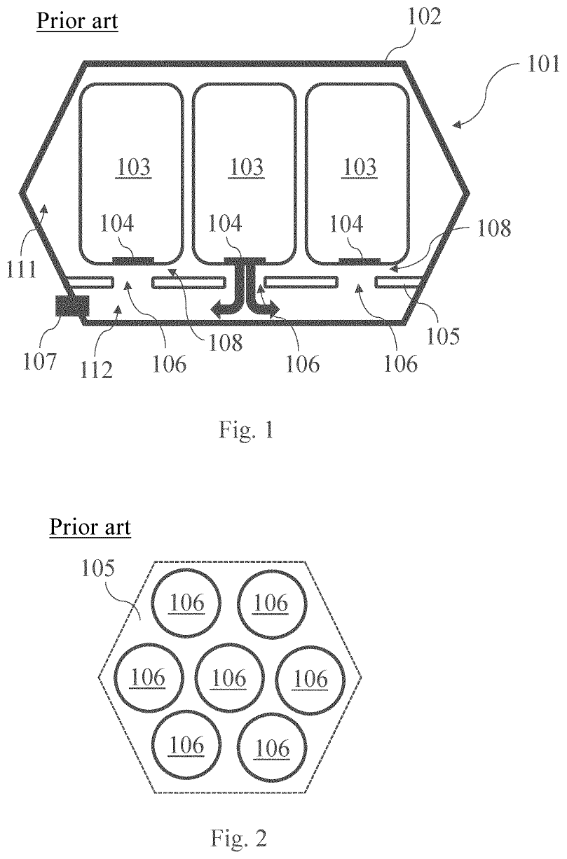

FIG. 1 illustrates, only schematically, the known battery store 101 according to the prior art. Furthermore, FIG. 2 schematically shows a plan view of a detail of a known stabilization plate 105.

The battery store 101 comprises a housing 102, the stabilization plate 105, which is disposed in the interior of the housing 102, and a plurality of battery cells 103.

The stabilization plate 105, e.g. a steel plate, has a plurality of passages 106, wherein each of the passages 106 is assigned to precisely one degassing opening 104 of one of the battery cells 103. In the event of thermal runaway, gas can thus be directed out of the defective battery cell 103 into the degassing portion 112 and be released through an opening 107 in the housing 102. The arrows leading out of the middle battery cell 103 illustrate, by way of example, hot degassing in the event of thermal runaway.

Furthermore, the cell portion 111 of the housing interior, in which the battery cells 103 are disposed, and the passages 106 in the stabilization plate 105 are filled with a potting compound, e.g. a foam.

In order to allow the filling with the potting compound when the known battery store 105 is being produced, the battery cells 103 are disposed spaced apart from the stabilization plate 105 such that a filling gap 108 is formed.

Due to the filling gap 108 being provided, installation space for the battery cells 103 is lost on account of the filling gap, however, and so the battery cells 103 have to have smaller dimensions. Consequently, the battery cells 103 are able to store less electrical energy, which, e.g., leads to a shorter range of a motor vehicle electrically drivable by the battery store 105.

On account of the filling gap, there is also a higher layer thickness of the potting compound between the respective degassing opening 104 in a battery cell 103 and the assigned passage 106 in the stabilization plate 105. This higher layer thickness creates a risk of a battery cell 103 bursting open at the sides or of a degassing at the terminal of a battery cell 103 in the event of thermal runaway.

Furthermore, thermal runaway can result in uncrimping or another detachment of the entire cell bottom from a battery cell 103. The detached cell bottom can wedge against the stabilization plate or close off the assigned passage 106 in the stabilization plate 105 such that the hot degassing is redirected through the filling gap 108 to adjacent battery cells 103. This can lead to critical heating of the adjacent battery cells 103 and, e.g., to a short circuit.

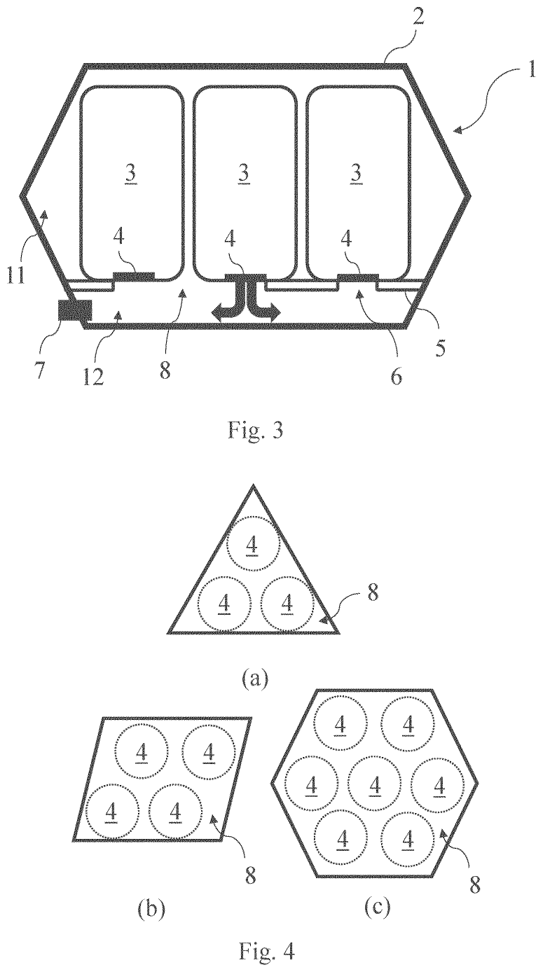

FIG. 3 illustrates, only schematically, the battery store 1 according to one embodiment of the present disclosure.

The battery store 1 comprises a housing 2 which forms a housing interior, and a stabilization plate 5 which is disposed in the housing interior and divides the housing interior into a degassing portion 12 and a cell portion 11.

The stabilization plate 5 can be formed of at least one electrically insulating material or by a metal plate which has at least one insulating layer and/or has an insulating plate lying thereagainst.

The battery store 1 further has a plurality of battery cells 3 which are disposed within the cell portion 11 and spaced apart from one another. The plurality of battery cells 3 can be designed as round cells.

The plurality of battery cells 3 have degassing openings 4 which can each be closed, e.g., by a bursting membrane. The degassing openings 4 are each formed on a side of one of the plurality of battery cells 3 facing the stabilization plate 5.

The stabilization plate 5 has passages 6, wherein the degassing openings 4 of the plurality of battery cells 3 are each assigned to one of the passages 6. In contrast to the known battery store 101, the passages 6 comprise a multi-cell passage 8 to which a plurality of the degassing openings 6 are assigned. Furthermore, it is also conceivable for the passages 6 to comprise a plurality of multi-cell passages 8 to each of which a plurality of the degassing openings 4 are assigned.

In the view of FIG. 3, the degassing openings 4 of the left battery cell 3 and of the middle battery cell 3 are assigned to the multi-cell passage 8. In other words, the left and middle battery cells 3 share the multi-cell passage 8 through which gas can be directed into the degassing portion 12 in the event of thermal runaway in at least one of the two battery cells 3 and released through an opening 7 in the housing 2, which opening is closed, e.g., by a bursting membrane. The arrows leading out of the middle battery cell 3 illustrate, by way of example, hot degassing in the event of thermal runaway.

FIG. 3 furthermore shows that the plurality of battery cells 3 lie against the stabilization plate 5. In contrast to the known battery store 101, no filling gap is thus formed in the battery store 1. As a result of the fact that a plurality of the degassing openings 4 are assigned to one of the passages 6, namely to the multi-cell passage 8, a space between at least two of the plurality of battery cells 3 is accessible via that one of the passages 6 and no filling gap is therefore necessary. Instead, spaces between the plurality of battery cells 3 and spaces between the plurality of battery cells 3 and the housing 2 can be fillable with a potting compound, e.g., a foam, via the accessible space. Alternatively, or in addition, the housing 2 can be fillable with an insulating compound such that the stabilization plate 5 and the plurality of battery cells 3 are at least partially, optionally completely, disposed in an insulating compound.

Correspondingly, passages 6 in the stabilization plate 5, spaces between the plurality of battery cells 3 and spaces between the plurality of battery cells 3 and the housing 2 can be at least partially filled with the potting compound.

FIG. 4 schematically shows a plan view of the multi-cell passage 8 in the assembled state, wherein the multi-cell passage 8 can have different shapes according to the shown optional embodiments.

In FIG. 4(a), the multi-cell passage 8 has a triangular shape, wherein three of the degassing openings 4 are assigned to the multi-cell passage 8.

In FIG. 4(b), the multi-cell passage 8 has a trapezoidal shape, wherein four of the degassing openings 4 are assigned to the multi-cell passage 8.

In FIG. 4(c), the multi-cell passage 8 has a hexagonal shape, wherein seven of the degassing openings 4 are assigned to the multi-cell passage 8.

### LIST OF REFERENCE SIGNS

1 Battery store
2 Housing
3 Battery cells
4 Degassing openings
5 Stabilization plate
6 Passages
7 Opening in the housing
8 Multi-cell passage
11 Cell portion of the housing interior
12 Degassing portion of the housing interior
101 Battery store (according to the prior art)
102 Housing (according to the prior art)
103 Battery cells (according to the prior art)
104 Degassing openings (according to the prior art)
105 Stabilization plate (according to the prior art)
106 Passages (according to the prior art)
107 Opening in the housing (according to the prior art)
108 Filling gap
111 Cell portion of the housing interior (according to the prior art)
112 Degassing portion of the housing interior (according to the prior art)

1.-10. (canceled)

11. A battery store for an electrically drivable motor vehicle, comprising:
a housing, which forms a housing interior;
a stabilization plate, which is disposed in the housing interior and divides the housing interior into a degassing portion and a cell portion, wherein the stabilization plate has passages; and
a plurality of battery cells, which are disposed within the cell portion and have degassing openings, wherein the degassing openings are each formed on a side of one of the plurality of battery cells facing the stabilization plate and are each assigned to one of the passages, wherein
the passages comprise at least one multi-cell passage to which a plurality of the degassing openings are assigned.

12. The battery store according to claim 11, wherein the at least one multi-cell passage has a triangular, trapezoidal or hexagonal shape.

13. The battery store according to claim 12, wherein the at least one multi-cell passage:
has the triangular shape, wherein three of the degassing openings are assigned to the at least one multi-cell passage;
has the trapezoidal shape, wherein four of the degassing openings are assigned to the at least one multi-cell passage; or
has the hexagonal shape, wherein seven of the degassing openings are assigned to the at least one multi-cell passage.

14. The battery store according to claim 11, wherein:
the plurality of battery cells are grouped in groups of battery cells connected in parallel; and
degassing openings of one of the groups are assigned to the at least one multi-cell passage.

15. The battery store according to claim 11, wherein the plurality of battery cells lie against the stabilization plate.

16. The battery store according to claim 11, wherein the stabilization plate is formed of at least one electrically insulating material or by a metal plate which has at least one insulating layer and/or has an insulating plate lying thereagainst.

17. The battery store according to claim 11, wherein the plurality of battery cells are designed as round cells and are disposed in the cell portion spaced apart from one another.

18. The battery store according to claim 11, wherein
spaces between the plurality of battery cells and spaces between the plurality of battery cells and the housing are at least partially filled with a potting compound, and/or
the stabilization plate and the plurality of battery cells are at least partially disposed in an insulating compound.

19. The battery store according to claim 11, wherein:
the degassing openings are each closed by a bursting membrane, and/or
the housing has an opening closed by a bursting membrane and formed adjacent to the degassing portion.

20. A motor vehicle, wherein the motor vehicle comprises a battery store according to claim 11.
